(19) United States
(12) Patent Application Publication
(10) Pub. No.: US 2021/0098921 A1
(43) Pub. Date: Apr. 1, 2021

(54) LOW-IMPEDANCE, LOW-HARMONIC SPRING CLIPS

(71) Applicant: Apple Inc., Cupertino, CA (US)

(72) Inventors: Mahmoud N. Mahmoud, Livermore, CA (US); Cheung-Wei Lam, San Jose, CA (US); Vaneet Pathak, Los Altos, CA (US); Ali Foudazi, Sunnyvale, CA (US)

(73) Assignee: Apple Inc., Cupertino, CA (US)

(21) Appl. No.: 17/030,932

(22) Filed: Sep. 24, 2020

Related U.S. Application Data
(60) Provisional application No. 62/906,574, filed on Sep. 26, 2019.

(51) Int. Cl. H01R 13/24; H01Q 1/52; H01R 13/426; H01R 24/78

(52) U.S. Cl. CPC H01R 13/2421; H01R 24/78; H01R 13/426; H01Q 1/52

(57) ABSTRACT

Spring clips that provide a reliable, low-impedance, low-harmonic path between various conductive enclosure components of electronic devices. These spring clips can include a low-impedance connection on each of two ends, where each end physically and electrically connects to an enclosure component of an electronic device. This can reduce an impedance between enclosure components and reduce the amplitude and harmonics of signals coupled onto them from a nearby antenna or other waveguide.

### CROSS REFERENCES TO RELATED APPLICATIONS

This application claims the benefit of U.S. provisional application No. 62/906,574, filed on Sep. 26, 2019, which is incorporated by reference.

### BACKGROUND

Electronic devices, such as portable computing devices, tablets, desktops, and all-in-one computers, cell phones, wearable computing devices, storage devices, portable media players, navigation systems, monitors and other devices, have become ubiquitous in recent years.

These electronic devices can include wireless communication circuits and components, such as circuits and components for Wi-Fi, cellular, Bluetooth, and other communication protocols. These circuits and components can include antennas and other waveguides that can be used for transmitting and receiving wireless signals.

These electronic devices can also include various enclosure components for a device enclosure or housing. These enclosure components can be metallic or otherwise conductive. The various enclosure components can be electrically connected to each other and grounded. The connections among these various enclosure components can have a high impedance, particularly at high frequencies. These enclosure components can be in proximity to the antennas and other waveguides of the wireless communication circuits.

In this arrangement, wireless signals on the antennas can couple onto the various enclosure components. To the extent that an enclosure component is grounded, this might not cause a problem. But since the connections among these various enclosure components can exhibit a high-impedance, high-harmonic behavior (particularly at high frequencies), the wireless signals on the antennas or other waveguides can generate voltages on some of the enclosure components and the connections or junctions among them. In particular, harmonics, such as the third harmonic, of signals (or the carrier portion of the signal) can be generated at these junctions. This frequency dependent behavior can also be nonlinear. This can pose problems, for example in attempting to comply with various regulatory standards and to limit Radio Frequency Interference (RFI) between two or more radios on the same device. It can also degrade the transceiver signals and lead to an increase in data transmission errors.

Thus, what is needed are components for connections that provide a reliable, low-impedance, low-harmonic path between various enclosure components of electronic devices.

### SUMMARY

Accordingly, embodiments of the present invention can provide spring clips that provide a reliable, low-impedance, low-harmonic path between various conductive enclosure components of electronic devices. These spring clips can include a low-impedance connection on each of two ends, where each end physically and electrically connects to an enclosure component of an electronic device. This can reduce an impedance between enclosure components and reduce the amplitude and harmonics of signals coupled onto them from a nearby antenna or other waveguide.

An illustrative embodiment of the present invention can provide spring clips having contacting portions at ends of the spring clips, where the contacting portions include two or more raised surfaces or spring contact junctions. Each spring clip can include a plate portion on a first end, the plate portion having an area for contacting a surface of a first enclosure component and having a first width in a first direction. The contacting portion having the two or more spring contact junctions for contacting a second enclosure component can be located on a second end. A connecting portion extending from the plate portion to the contacting portion in a second direction can join the two. The first direction can be orthogonal to the second direction. The connecting portion can have a second width in the first direction, wherein the second width is narrower than the first width.

In these and other embodiments of the present invention, the plurality of spring contact junctions can comprise two spring contact junctions. The two spring contact junctions can be adjacent or nearby and in a line in the first direction. In these and other embodiments of the present invention, the two spring contact junctions can be adjacent or nearby and in a line in the second direction. In these and other embodiments of the present invention, the two spring contact junctions can be adjacent or nearby and in a line in a direction that is between the first and the second direction. In these and other embodiments of the present invention, for each spring clip, the plurality of spring contact junctions can comprise three spring contact junctions. These three spring contact junctions can be adjacent and in a line in the first direction. In these and other embodiments of the present invention, the three spring contact junctions can be adjacent and in a line in the second direction. The three spring contact junctions can instead be arranged in a triangle or other pattern. Using embodiments of the present invention that include two raised surfaces or spring contact junctions can reduce harmonic noise power generated by more than 6 dB. Using additional spring contact junctions can further reduce impedance and the resulting noise power. For example, using embodiments of the present invention that include three spring contact junctions can reduce harmonic noise power generated by more than 9 dB.

These spring clips having two or more spring contact junctions can provide other advantages in addition to a low-impedance, low-harmonic performance. For example, since two spring contact junctions are available to form an electrical connection, the presence of dust or other contaminant between one spring contact junctions and an enclosure component might not render the spring clip ineffective. This redundancy can lead to a more robust, reliable connection provided by the spring clip.

Also, two spring contact junctions providing two points of contact can provide a more mechanically stable connection between a spring clip and an enclosure component. Moreover, the force between each spring contact junction and enclosure component can be reduced, thereby reducing wear on the adjacent surfaces.

In these and other embodiments of the present invention, spring clips can be used to electrically connect various housing or device enclosure components. For example, they can be used to connect support plates (which can provide support for flexible circuit boards, displays, main-logic boards, or other components), housing frames (which can provide a structure for the electronic device enclosure and a point of attachment for connectors, control buttons, and other controls), shield plates (which can provide shielding for noise-generating circuits, such as wireless communication circuits, high-speed output drivers and other circuits), and other housing or device enclosure components.

Various embodiments of the present invention can provide spring clips formed using various methods. For example, spring clips consistent with embodiments of the present invention can be formed by stamping, lathing, deep drawing, metal-injection molding, 3-D printing, by using computer numerical control (CNC) machines, or by other techniques.

In these and other embodiments of the present invention, spring contact junctions on a contacting portion of a spring clip can be formed in various ways. For example, they can be stamped into the spring clips as dimples. They can be forged, deep drawn, or coined. They can be formed along with rest of the spring clip using metal-injection molding, 3-D printing, or other technique. They can be formed separately and attached to the spring clips by soldering, riveting, or other technique. They can be formed on a surface of the spring contacts, for example by sintering or other method. This can allow the use of a material such as gold or silver for the spring contact junctions while allowing the use of another material, such as stainless steel, for the remainder of the spring clip, thereby conserving resources.

In these and other embodiments of the present invention, these spring clip can be formed of various materials. For example, they can be formed of, or can include, stainless steel, gold, titanium, silver, palladium, or other material or combination of materials.

While embodiments of the present invention are particularly well-suited for grounding enclosure components of an electronic device, these and other embodiments of the present invention can provide spring clips that can convey positive power supplies, negative power supplies, other types of supplies, voltages, control signals, or other electronic voltages or signals.

Embodiments of the present invention can be used with various types of electronic devices, such as portable computing devices, tablets, laptops, desktops, and all-in-one computers, cell phones, wearable computing devices, audio devices, storage devices, portable media players, navigation systems, monitors, adapters, automotive systems, and other devices.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a portion of an electronic device according to an embodiment of the present invention;

FIG. 2 illustrates a portion of the electronic device of FIG. 1;

FIG. 3 illustrates an underside of the portion of an electronic device shown in FIG. 2;

FIG. 4 illustrates a spring clip according to an embodiment of the present invention;

FIG. 5 illustrates a portion of an electronic device according to an embodiment of the present invention;

FIG. 6 illustrates a portion of the electronic device of FIG. 5;

FIG. 7 illustrates a side view of the portion of an electronic device shown in FIG. 6;

FIG. 8 illustrates a spring clip according to an embodiment of the present invention;

FIG. 9 illustrates a spring clip according to an embodiment of the present invention; and

FIG. 10 illustrates a spring clip according to an embodiment of the present invention.

### DESCRIPTION OF ILLUSTRATIVE EMBODIMENTS

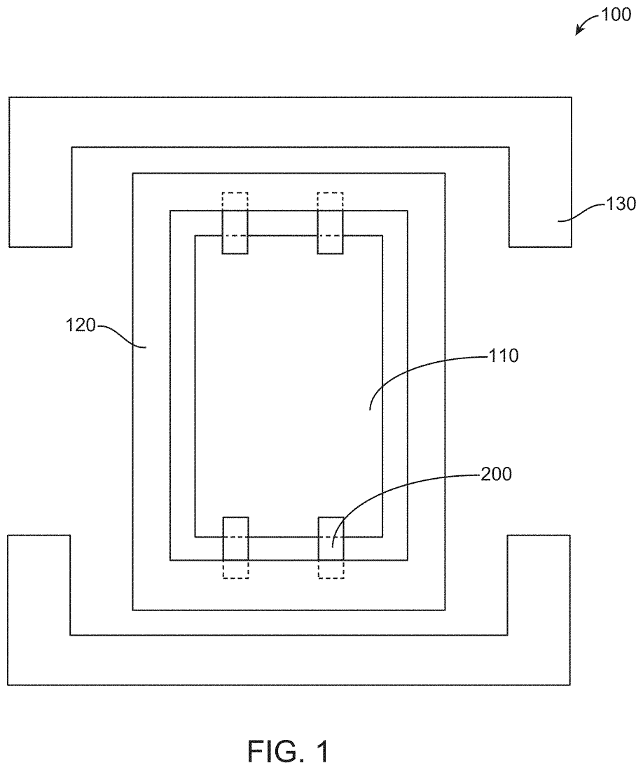

FIG. 1 illustrates a portion of an electronic device according to an embodiment of the present invention. This figure, as with the other included figures, is shown for illustrative purposes and does not limit either the possible embodiments of the present invention or the claims.

Electronic device 100 can include support plate 110, housing frame 120, and antennas 130. Support plate 110 can be electrically connected to housing frame 120 through spring clips 200. Support plate 110 can provide support for a flexible circuit board, display, main-logic board, or other component of electronic device 100. Housing frame 120 can provide a frame structure for electronic device 100. Housing frame 120 can also provide support for connectors, power and volume controls, and other device enclosure components. Spring clips 200 can electrically connect support plate 110 to housing frame 120. However, for conventional spring clips, these connections can have a relatively high impedance associated with them at high frequencies. As a result, this connection can have relatively high harmonic generation associated with them at high frequencies.

Antennas 130 can transmit and receive wireless signals, such as Wi-Fi, cellular, Bluetooth, and other types of signals. As antennas 130 transmit and receive wireless signals, the wireless signals can couple to other conductive enclosure components in electronic device 100. For example, these wireless signals can couple to support plate 110 and housing frame 120. To the extent that support plate 110 and housing frame 120 are well-grounded, the coupling from the wireless signals can be negligible. But again, the impedance of spring clips 200 might mean, for example, that housing frame 120 is not thoroughly grounded. The coupling from the wireless signals can then generate signals on housing frame 120. The nonlinear behavior of the spring contact junction can lead to harmonics of this signal, in particular the third harmonic, across the impedance of conventional spring clips. The resulting harmonics can degrade system performance, lead to RFI between co-located radios, and can make regulatory compliance more difficult. Accordingly, embodiments of the present invention can provide spring clips 200 having a lower impedance. An example is shown in the following figures.

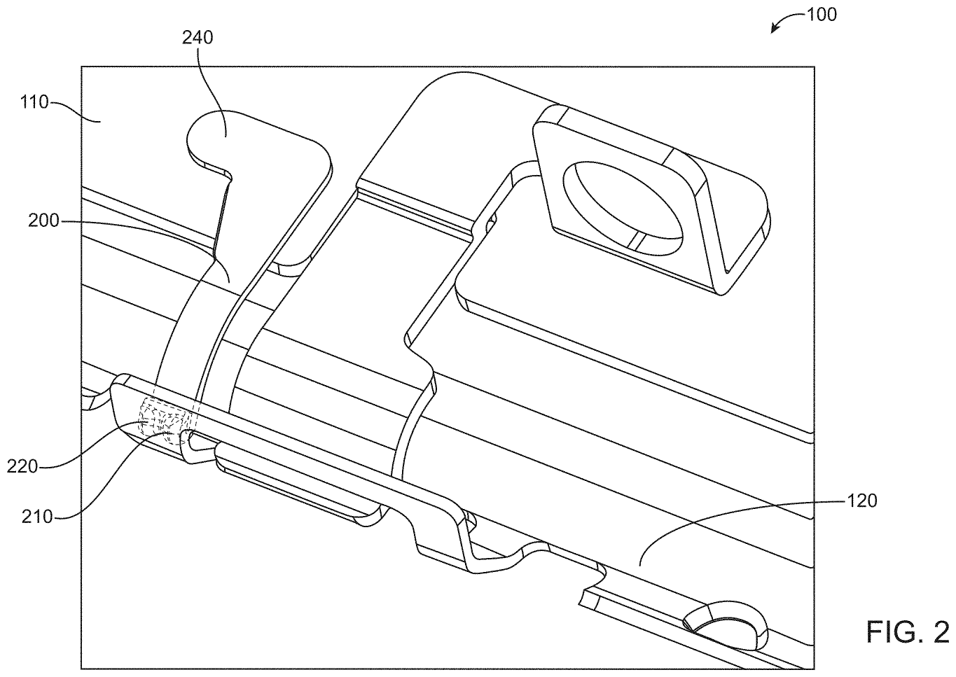

FIG. 2 illustrates a portion of the electronic device of FIG. 1. In this example, spring clip 200 can electrically connect support plate 110 to housing frame 120 of electronic device 100. Spring clip 200 can include a plate portion 240 having an area for physically and electrically connecting to support plate 110. Spring clip 200 can further include a contacting portion including spring contact junctions 210 and 220. Spring contact junctions 210 and 220 can physically and electrically connect to housing frame 120 as shown. Having multiple spring contact junctions 210 and 220 on spring clip 200 can help to reduce the impedance between support plate 110 and housing frame 120 by providing multiple current pathways. This reduction in impedance can help to reduce the actual signal coupling onto housing frame 120 and support plate 110 from antenna 130 (shown in FIG. 1.)

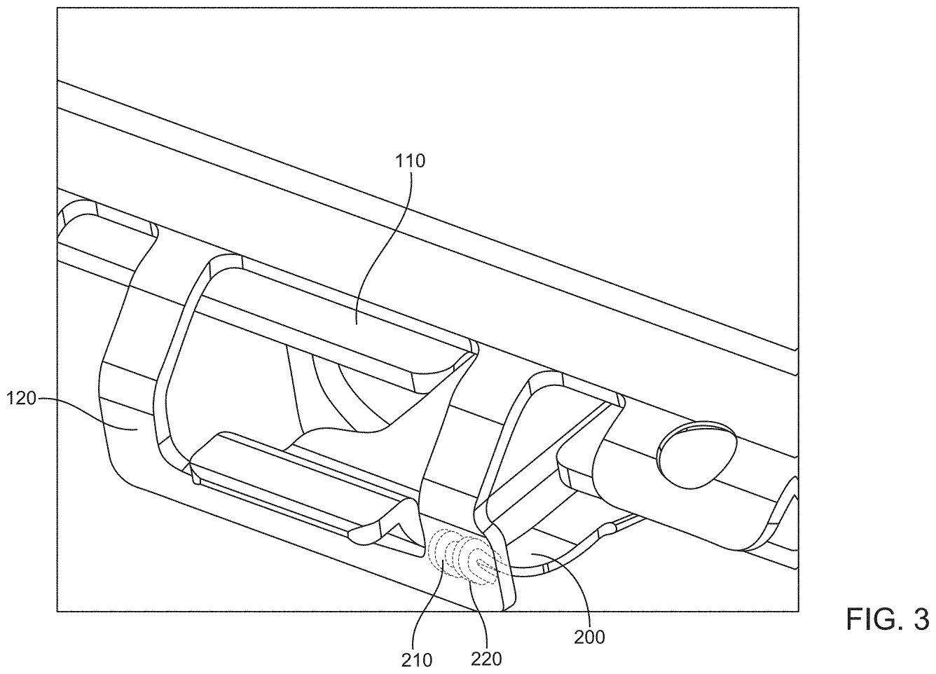

FIG. 3 illustrates an underside of the portion of an electronic device shown in FIG. 2. As before, spring clip 200 can electrically connect support plate 110 to housing frame 120. Spring contact junctions 210 and 220 of spring clip 200 can physically and electrically contact a surface of housing frame 120.

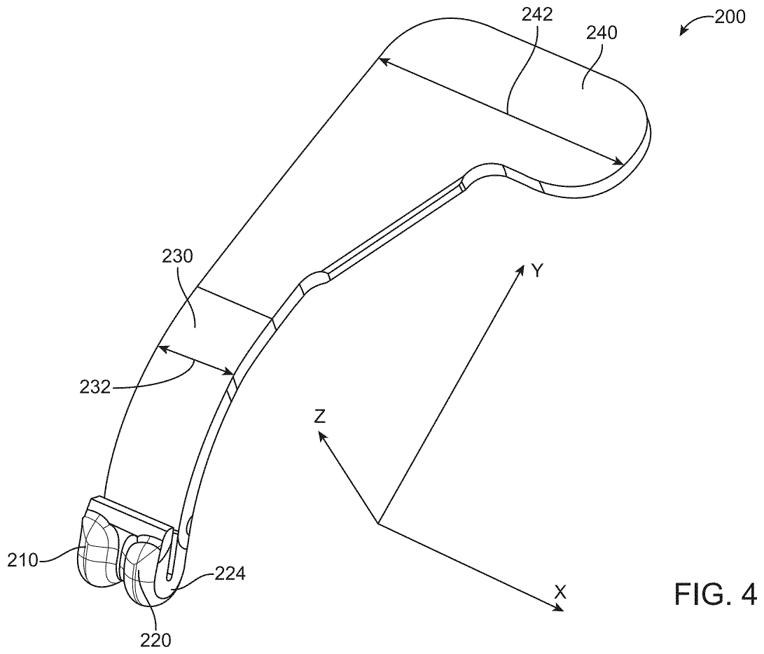

FIG. 4 illustrates a spring clip according to an embodiment of the present invention. Spring clip 200 can include a plate portion 240 having an area for contacting a first enclosure component in an electronic device. This first enclosure component can be a support plate 110 as shown in FIG. 1, or another enclosure component in an electronic device. Plate portion 240 of spring clip 200 can have a first width 242 in an X direction. Spring clip 200 can further include a contacting portion having spring contact junctions 210 and 220, which can be aligned with each other in the X direction. Spring contact junctions 210 and 220 can contact a second enclosure component in an electronic device. This second enclosure component can be housing frame 120 as shown in FIG. 1, or another enclosure component in an electronic device. Connecting portion 230 can extend in the Y direction to join plate portion 240 to the contacting portions including spring contact junctions 210 and 220. Connecting portion 230 can be folded back on itself at bend 224, thereby exposing spring contact junctions 210 and 220 as shown. Spring contact junctions 210 and 220 can extend back around bend 224 to a backside (not shown) of spring clip 200. Connecting portion 230 can have a second width 232 in the X direction. In these and other embodiments of the present invention, first width 242 can be greater than second width 232.

A large plate portion 240 having a width 242 that is greater than a width 232 of connecting portion 230 can provide a low-impedance connection to a first enclosure component by providing a large contacting area. Having a narrow connecting portion 630 can save space in an electronic device. Multiple spring contact junctions 210 and 220 can reduce impedance by providing multiple current pathways between spring clip 200 and a second enclosure component. Spring clips 200 (and 600, 900, and 1000 as shown in other examples) having two or more spring contact junctions 210 and 220 can provide other advantages along with a reduction in impedance. For example, since two spring contact junctions 210 and 220 are available to form an electrical connection, the presence of dust or other contaminant between one spring contact junction and an enclosure component, such as support plate 110 or housing frame 120, might not render spring clip 200 ineffective. This redundancy can lead to a more robust, reliable connection provided by spring clip 200.

Also, spring contact junctions 210 and 220 providing two points of contact can provide a more mechanically stable connection between spring clip 200 and an enclosure component, such as support plate 110 or housing frame 120. The force between each spring contact junction 210 and 220 and an enclosure component can be reduced, thereby reducing wear on the adjacent surfaces of spring clip 200 and the contacted enclosure component.

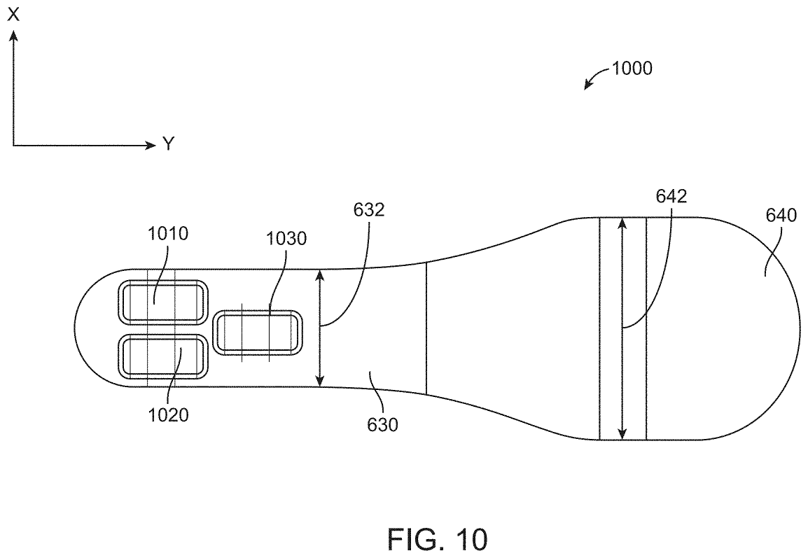

In these and other embodiments of the present invention, a spring clip can comprise two or more spring contact junctions. The two spring contact junctions can be adjacent or nearby and in a line in the X direction as shown. In these and other embodiments of the present invention, the two spring contact junctions can be adjacent or nearby and in a line in the Y direction. In these and other embodiments of the present invention, the two spring contact junctions can be adjacent or nearby and in a line in a direction that is between the X direction and the Y direction. In these and other embodiments of the present invention, for each spring clip, the plurality of spring contact junctions can comprise three spring contact junctions. These three spring contact junctions can be adjacent and in a line in X direction. In these and other embodiments of the present invention, the three spring contact junctions can be adjacent and in a line in the Y direction. The three spring contact junctions can be arranged in a triangle or other pattern. One such pattern is shown in FIG. 10 below.

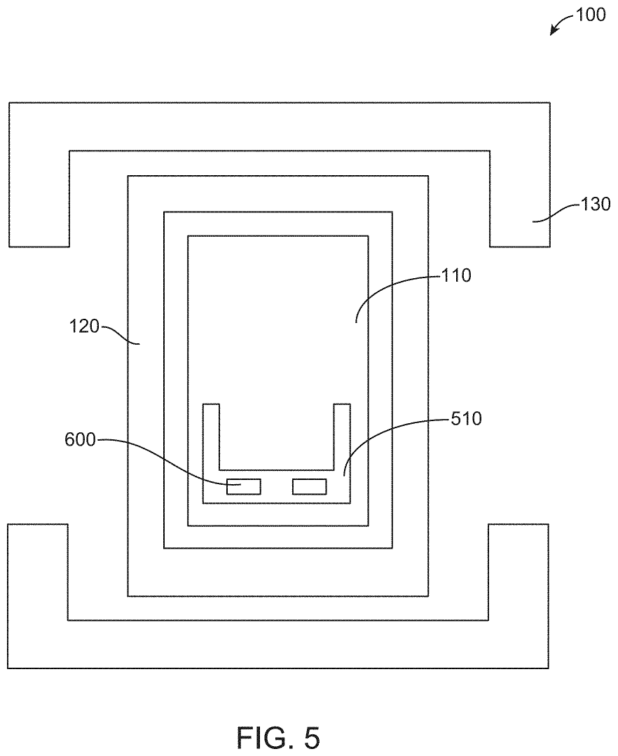

FIG. 5 illustrates a portion of an electronic device according to an embodiment of the present invention. As before, electronic device 100 can include support plate 110, housing frame 120, and antenna 130. Electronic device 100 can further include shield plate 510. Shield plate 510 can provide shielding for wireless circuits, high-speed output circuits, and other noise inducing circuits and components. Shield plate 510 can be electrically connected to support plate 110 through spring clips 600. Spring clips 200, as shown in FIG. 1, can also be included.

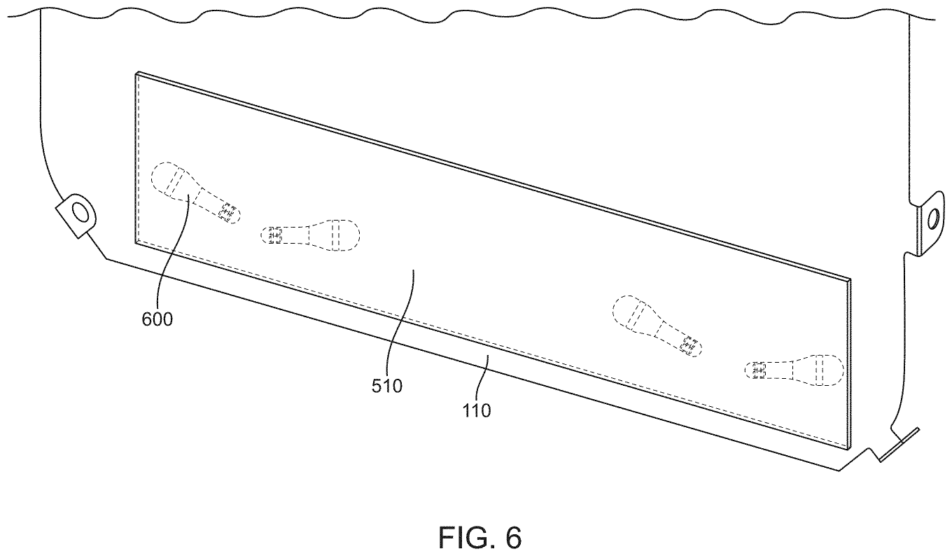

FIG. 6 illustrates a portion of the electronic device of FIG. 5. In this example, shield plate 510 can be electrically connected to support plate 110 through spring clips 600.

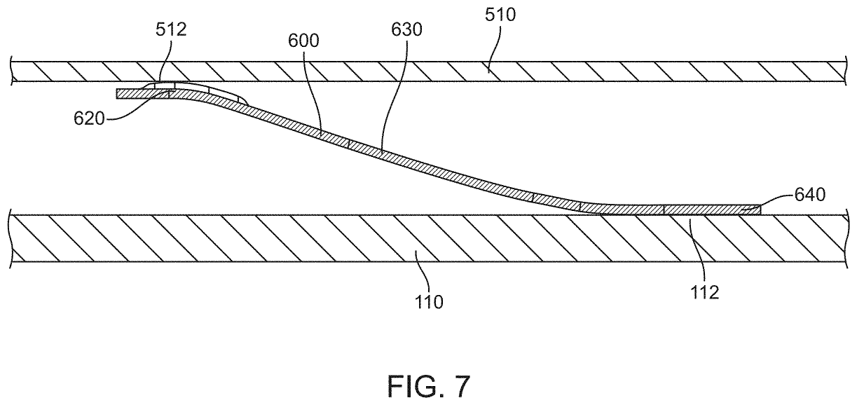

FIG. 7 illustrates a side view of the portion of an electronic device shown in FIG. 6. In this example, spring clip 600 can electrically connect shield plate 510 to support plate 110. Spring clip 600 can include spring contact junction 620, which can physically and electrically contact shield plate 510 at location 512. Spring clip 600 can further include plate portion 640, which can physically and electrically contact support plate 110 at location 112. Spring clip 600 can further include connecting portion 630, which can join a contacting portion including spring contact junction 620 to plate portion 640. In these and other bottoms of the present invention, the orientation of spring clip 600 can be reversed, such that spring contact junction 620 can physically and electrically contact support plate 110, and plate portion 640 can physically and electrically contact shield plate 510.

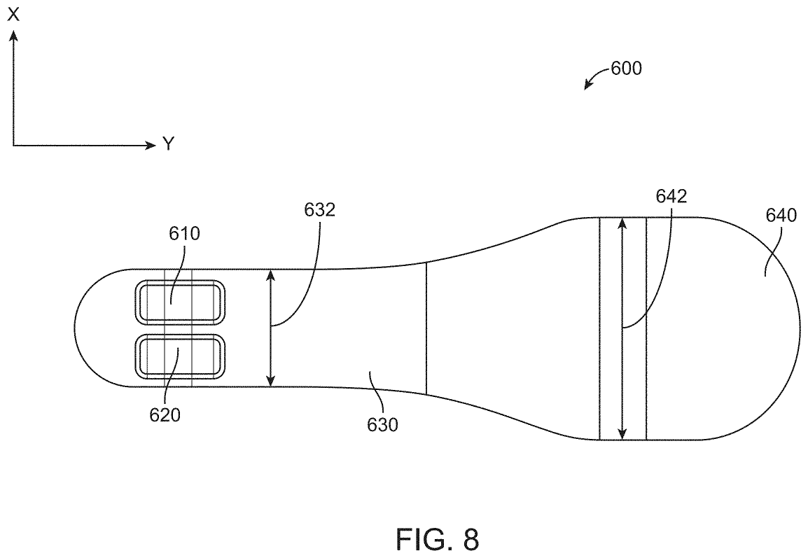

FIG. 8 illustrates a spring clip according to an embodiment of the present invention. Spring clip 600 can be used as spring clip 200, or a another spring clip in various embodiments of the present invention. Spring clip 600 can include plate portion 640 having an area for contacting a first enclosure component in an electronic device. This first enclosure component can be a support plate 110 as shown in FIG. 5, or another enclosure component in an electronic device. Plate portion 640 of spring clip 600 can have a first width 642 in the X direction. Spring clip 600 can further include a contacting portion having spring contact junctions 610 and 620, which can be aligned with each other in the X direction. Spring contact junctions 610 and 620 can contact a second enclosure component in an electronic device. This second enclosure component can be shield plate 510 or support plate 110 as shown in FIG. 5, or another enclosure component in an electronic device. Connecting portion 630 can extend in the Y direction to join plate portion 640 to the contacting portion including spring contact junctions 610 and 620. Connecting portion 630 can have a second width 232 in the X direction. In these and other embodiments of the present invention, first width 642 can be greater than second width 632.

A large plate portion 640 having a width 642 that is greater than a width 632 of connecting portion 630 can provide a low-impedance connection to a first enclosure component by providing a large contacting area. Having a narrow connecting portion 630 can save space in an electronic device. Multiple spring contact junctions 610 and 620 can reduce impedance by providing multiple current pathways between spring clip 600 and a second enclosure component. Spring clips 600 (and 200, 900, and 1000 as shown in other examples) having two or more spring contact junctions can provide other advantages along with a reduction in impedance. For example, since two spring contact junctions 610 and 620 are available to form an electrical connection, the presence of dust or other contaminant between one spring contact junction and an enclosure component, such as support plate 110, housing frame 120, or shield plate 510, might not render spring clip 600 ineffective. This redundancy can lead to a more robust, reliable connection provided by spring clip 600.

Also, spring contact junctions 610 and 620 providing two points of contact can provide a more mechanically stable connection between spring clip 600 and an enclosure component, such as support plate 110, housing frame 120, or shield plate 510. The force between each spring contact junction 610 and 620 and an enclosure component can be reduced, thereby reducing wear on the adjacent surfaces of spring clip 600 and the contacted enclosure component.

In this example, spring contact junctions 610 and 620 can be aligned in the X direction. In these and other embodiments of the present invention, spring contact junctions can be aligned in the Y direction. An example is shown in the following figure.

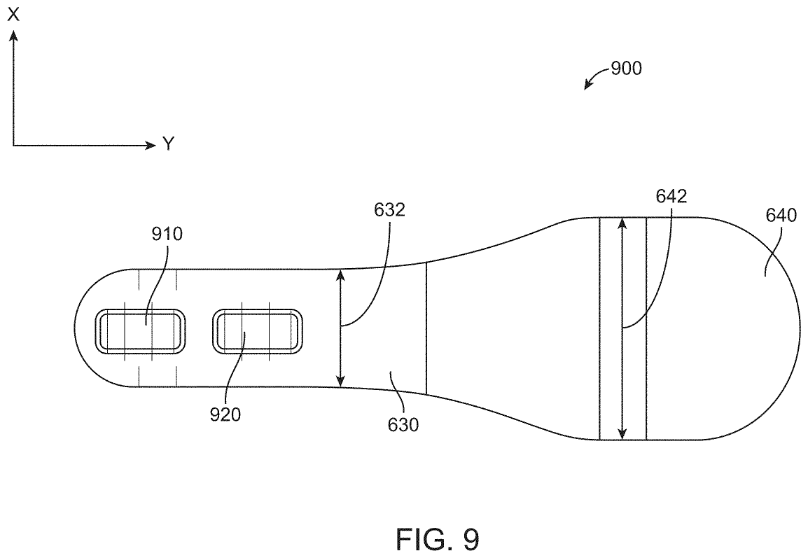

FIG. 9 illustrates a spring clip according to an embodiment of the present invention. Spring clip 900 can be used as spring clip 200, 600, or other spring clip in these and other embodiments of the present invention. Spring clip 900 can include plate portion 640 having an area for contacting a first enclosure component in an electronic device. This first enclosure component can be a support plate 110 or shield plate 510 as shown in FIG. 5, or another enclosure component in an electronic device. Plate portion 640 of spring clip 900 can have a first width 642 in an X direction. Spring clip 900 can further include a contacting portion having spring contact junctions 910 and 920, which can be aligned with each other in the Y direction. Spring contact junctions 910 and 920 can contact a second enclosure component in an electronic device. This second enclosure component can be shield plate 510 or support plate 110 as shown in FIG. 5, or another enclosure component in an electronic device. Connecting portion 630 can extend in the Y direction to join plate portion 640 to the contacting portion including spring contact junctions 910 and 920. Connecting portion 630 can have a second width 632 in the X direction. In these and other embodiments of the present invention, first width 642 can be greater than second width 632.

In the above example, spring contact junctions 910 and 920 can be aligned in the Y direction. In these and other embodiments of the present invention, the two spring contact junctions can be adjacent or nearby and in a line in the X direction, the Y direction, or a direction between these two. In these and other embodiments of the present invention, three spring contact junctions can be included. These three spring contact junctions can be adjacent and in a line in the X direction. In these and other embodiments of the present invention, the three spring contact junctions can be adjacent and in a line in the Y direction. The three spring contact junctions can be arranged in a triangle or other pattern. An example is shown in the following figure.

FIG. 10 illustrates a spring clip according to an embodiment of the present invention. Spring clip 1000 can be used as spring clip 200, 600, 900, or other spring clip in these and other embodiments of the present invention. Spring clip 1000 can include plate portion 640 having an area for contacting a first enclosure component in an electronic device. This first enclosure component can be a support plate 110 or shield plate 510 as shown in FIG. 5, or another enclosure component in an electronic device. Plate portion 640 of spring clip 1000 can have a first width 642 in an X direction. Spring clip 1000 can further include a contacting portion having spring contact junctions 1010, 1020, and 1030. Spring contact junctions 1010 and 1020 can be aligned with each other in the X direction, while spring contact junction 1030 can be between them and offset in the Y direction. Spring contact junctions 1010, 1020, and 1030 can contact a second enclosure component in an electronic device. This second enclosure component can be shield plate 510 or support plate 110 as shown in FIG. 5, or another enclosure component in an electronic device. Connecting portion 630 can extend in the Y direction to join plate portion 640 to the contacting portion including spring contact junctions 1010, 1020, and 1030. Connecting portion 630 can have a second width 232 in an X direction. In these and other embodiments of the present invention, first width 642 can be greater than second width 632.

While embodiments of the present invention are particularly well-suited for grounding portions of an electronic device, these and other embodiments of the present invention can provide spring clips that can convey positive power supplies, negative power supplies, other types of supplies, voltages, control signals, or other electronic voltages or signals.

In these and other embodiments of the present invention, spring clips can be used to electrically connect various housing or device enclosure components. For example, they can be used to connect support plates (which can provide support for flexible circuit boards, displays, main-logic boards, or other components), housing frames (which can provide a structure for the electronic device enclosure and a point of attachment for connectors, control buttons, and other controls), shield plates (which can provide shielding for noise-generating circuits, such as wireless communication circuits, high-speed output drivers and other circuits), and other housing or device enclosure components.

Various embodiments of the present invention can provide spring clips formed using various methods. For example, spring clips consistent with embodiments of the present invention can be formed by stamping, lathing, deep drawing, metal injection molding, 3-D printing, by using computer numerical control (CNC) machines, or by other techniques.

In these and other embodiments of the present invention, spring contact junctions on a contacting portion of a spring clip can be formed in various ways. For example, they can be stamped into the spring clips as dimples. They can be forged, deep drawn, or coined. They can be formed along with rest of the spring clip using metal-injection molding, 3-D printing, or other technique. They can be formed separately and attached to the spring clip by soldering, riveting, or other technique. They can be formed on a surface of the spring contacts, for example by sintering or other method. This can allow the use of a material such as gold or silver for the spring contact junctions while allowing the use of another material, such as stainless steel, for the remainder of the spring clip, thereby conserving resources.

In these and other embodiments of the present invention, these spring clip can be formed of various materials. For example, they can be formed of, or can include, stainless steel, gold, titanium, silver, palladium, or other material or combination of materials.

Embodiments of the present invention can be used with various types of electronic devices, such as portable computing devices, tablets, laptops, desktops, and all-in-one computers, cell phones, wearable computing devices, audio devices, storage devices, portable media players, navigation systems, monitors, adapters, automotive systems, and other devices.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A spring clip comprising:
a plate portion having an area for contacting a surface of a first enclosure component and having a first width in a first direction;
a contacting portion having a plurality of spring contact junctions for contacting a second enclosure component; and
a connecting portion extending from the plate portion to the contacting portion in a second direction, the connecting portion having a second width in the first direction, wherein the second width is narrower than the first width and the first direction is orthogonal to the second direction.

2. The spring clip of claim 1 wherein the plurality of spring contact junctions comprises two spring contact junctions.

3. The spring clip of claim 2 wherein the two spring contact junctions are adjacent and in a line in the first direction.

4. The spring clip of claim 2 wherein the two spring contact junctions are adjacent and in a line in the second direction.

5. The spring clip of claim 1 wherein the plurality of spring contact junctions comprises three spring contact junctions.

6. The spring clip of claim 1 wherein the spring clip is formed of stainless steel.

7. The spring clip of claim 1 wherein the spring clip is formed of gold.

8. An electronic device comprising:
a support plate;
a housing frame at least partially around the support plate;
an antenna; and
a plurality of spring clips to electrically connect the support plate to the housing frame, each spring clip comprising:
a plate portion having an area for contacting a surface of the support plate and having a first width in a first direction;
a contacting portion having a plurality of spring contact junctions for contacting the housing frame; and
a connecting portion extending from the plate portion to the contacting portion in a second direction, the connecting portion having a second width in the first direction, wherein the second width is narrower than the first width and the first direction is orthogonal to the second direction.

9. The electronic device of claim 8 wherein for each spring clip, the plurality of spring contact junctions comprises two spring contact junctions.

10. The electronic device of claim 9 wherein the two spring contact junctions are adjacent and in a line in the first direction.

11. The electronic device of claim 8 wherein the plurality of spring contact junctions comprises three spring contact junctions.

12. The electronic device of claim 8 wherein each spring clip is formed of stainless steel.

13. An electronic device comprising:
a support plate;
a shield plate;
a housing frame at least partially around the support plate;
an antenna; and
a first plurality of spring clips to electrically connect the support plate to the shield plate, each spring clip comprising:
a plate portion having an area for contacting a surface of one of the support plate and the shield plate and having a first width in a first direction;
a contacting portion having a plurality of spring contact junctions for contacting the other of the support plate or the shield plate; and
a connecting portion extending from the plate portion to the contacting portion in a second direction, the connecting portion having a second width in the first direction, wherein the second width is narrower than the first width and the first direction is orthogonal to the second direction.

14. The electronic device of claim 13 further comprising a second plurality of spring clips to electrically connect the support plate to the housing frame.

15. The electronic device of claim 14 wherein for each spring clip in the first plurality of spring clips, the plurality of spring contact junctions comprises two spring contact junctions.

16. The electronic device of claim 15 wherein for each spring clip in the first plurality of spring clips, the two spring contact junctions are adjacent and in a line in the first direction.

17. The electronic device of claim 15 wherein for each spring clip in the first plurality of spring clips, the two spring contact junctions are adjacent and in a line in the second direction.

18. The electronic device of claim 13 wherein for each spring clip in the first plurality of spring clips, the plurality of spring contact junctions comprises three spring contact junctions.

19. The electronic device of claim 13 wherein for each spring clip in the first plurality of spring clips, the spring clip is formed of stainless steel.

20. The electronic device of claim 13 wherein for each spring clip in the first plurality of spring clips, the spring clip is formed of gold.
